(19) United States
(12) Patent Application Publication
(10) Pub. No.: US 2015/0316784 A1
(43) Pub. Date: Nov. 5, 2015

(54) RIMLESS EYEGLASSES

(71) Applicant: Oceanus Investment Inc., Mahe (SC)

(72) Inventor: Zhao-Yun HE, Shenzhen (CN)

(21) Appl. No.: 14/698,250

(22) Filed: Apr. 28, 2015

(30) Foreign Application Priority Data
Apr. 30, 2014 (CN) 201420221855.2
Jul. 25, 2014 (CN) 201420416076.8
Jan. 24, 2015 (CN) 201510037180.5

(51) Int. Cl. G02C 1/02; G02C 5/14

(52) U.S. Cl. CPC G02C 1/02; G02C 5/14

(57) ABSTRACT

A pair of rimless eyeglasses includes a pair of lenses, a bridge and a bridge fixing unit. Each of the lenses is formed with an inner through hole. The bridge fixing unit includes a pair of bridge engaging members disposed on the bridge, each of which has a bridge engaging head, and a pair of bridge fixing members, each of which has a bridge fixing wall defining a receiving space. The bridge engaging heads and/or the bridge fixing walls are resiliently deformable. The bridge engaging heads are respectively inserted into the inner through holes. The bridge fixing walls are respectively inserted into the inner through holes such that the bridge engaging heads respectively, detachably and fittingly engage in the receiving spaces to fix the lenses to the bridge.

### CROSS-REFERENCE TO RELATED APPLICATIONS

This application claims priorities of Chinese Patent Application No. 201420416076.8, filed on Jul. 25, 2014, Chinese Patent Application No. 20140221855.2, filed on Apr. 30, 2014, and Chinese Patent Application No. 201510037180.5, filed on Jan. 24, 2015.

### FIELD

The disclosure relates to a pair of eyeglasses, more particularly to a pair of rimless eyeglasses.

### BACKGROUND

Referring to FIG. 1, a pair of conventional rimless eyeglasses 1 includes a lens unit 11, a bridge unit 12, two nose pads 13 and two temple units 14. Since the conventional rimless eyeglasses 1 have symmetrical left and right parts, only the left part of the conventional rimless eyeglasses 1 is illustrated in FIG. 1 for the sake of brevity.

The lens unit 11 includes two spaced-apart lenses 111, each of which is formed with an inner through hole 112 proximate to the other one of the lenses 111, and an outer through hole 113 distal from the other one of the lenses 111.

The bridge unit 12 includes a strip-shaped bridge 121, two threaded holes 122 that are respectively formed in opposite ends of the bridge 121, and two screws 123. Each of the threaded holes 122 is aligned with the inner through hole 112 of a respective one of the lenses 111. Each of the screws 123 is threaded into a respective one of aligned pairs of the inner through holes 112 and the threaded holes 122. The lenses 111 are thereby connected to the bridge 121.

The nose pads 13 extend from the bridge 121 for abutting against a user's nasal bridge and supporting the bridge 121.

Each of the temple units 14 includes a connecting body 143 formed with a threaded hole 144, a hinge 142 disposed on the connecting body 143 opposite to the threaded hole 144, a temple body 141 pivotally connected to the hinge 142, and a screw 145. The threaded hole 144 of each of the temple units 14 is aligned with the outer through hole 113 of a respective one of the lenses 111. The screw 145 of each of the temple units 14 is threaded into a respective one of aligned pairs of the outer through holes 113 and the threaded holes 144. The temple units 14 are thereby connected to the lenses 111. The temple body 141 of each of the temple units 14 is pivotable about the hinge 142 and relative to a respective one of the lenses 111 for converting the conventional rimless eyeglasses 1 between a storable state and a wearable state.

However, since the lenses 111 are drilled with the inner through holes 112 and the outer through holes 113, then firmly fixed through engagement of the screws 123, 145 and the threaded holes 122, 144, assembly or disassembly of the conventional rimless eyeglasses 1 during manufacture or maintenance is a complicated and time-consuming process. Moreover, the lenses 111 may break due to stress concentration caused by tight engagement between the screws 123, 145 and the threaded holes 122, 144. Further, the screws 123, 145 may work loose from the threaded holes 122, 144 after long-term use of the conventional rimless eyeglasses 1, which may cause the lenses 111 to be detached from the bridge 121 and the temple units 14.

Therefore, it is desirable to provide a pair of improved rimless eyeglasses.

Therefore, an aspect of the present disclosure is to provide a pair of rimless eyeglasses that is able to overcome at least one of the aforesaid drawbacks associated with the conventional rimless eyeglasses.

According to the disclosure, the rimless eyeglasses include a lens unit, a bridge unit and a bridge fixing unit. The lens unit includes a pair of spaced-apart lenses. Each of the lenses is formed with an inner through hole unit that has at least one non-circular inner through hole proximate to the other one of the lenses. The bridge unit includes a bridge. The bridge fixing unit includes a pair of bridge engaging members that are disposed on opposite ends of the bridge, and a pair of bridge fixing members. Each of the bridge engaging members has a bridge engaging base and a bridge engaging head that projects from the bridge engaging base. Each of the bridge fixing members has a bridge fixing base and a bridge fixing wall that projects from the bridge fixing base and that defines a receiving space. The bridge engaging heads of the bridge engaging members and/or the bridge fixing walls of the bridge fixing members are resiliently deformable. The bridge engaging head of each of the bridge engaging members is inserted into the inner through hole of a respective one of the inner through hole units of the lenses from one side of the lenses. The bridge fixing wall of each of the bridge fixing members is inserted into the inner through hole of a respective one of the inner through hole units of the lenses from an opposite side of the lenses such that the bridge engaging head of each of the bridge engaging members detachably and fittingly engages in the receiving space of the bridge fixing wall of a respective one of the bridge fixing members so as to fix the lenses to the bridge.

### BRIEF DESCRIPTION OF THE DRAWINGS

Other features and advantages of the present disclosure will become apparent in the following detailed description of the embodiments with reference to the accompanying drawings, of which:

FIG. 1 is a fragmentary partly cross-sectional view of a pair of conventional rimless eyeglasses;

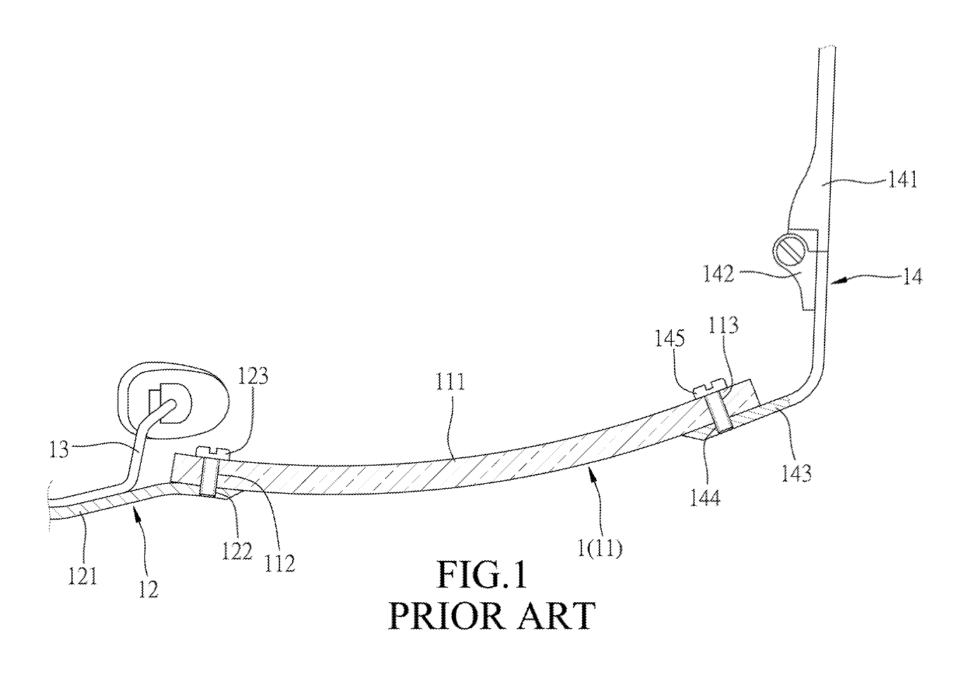

FIG. 2 is a fragmentary partly exploded perspective view of a first embodiment of a pair of rimless eyeglasses of the present disclosure;

FIG. 3 is a fragmentary partly cross-sectional view of the first embodiment;

FIG. 4 is a fragmentary partly exploded perspective view of a second embodiment of the rimless eyeglasses of the present disclosure;

FIG. 5 is a fragmentary partly exploded cross-sectional view of the second embodiment;

FIG. 6 is a fragmentary partly exploded cross-sectional view of a third embodiment of the rimless eyeglasses of the present disclosure;

FIG. 7 is a fragmentary partly exploded cross-sectional view of a fourth embodiment of the rimless eyeglasses of the present disclosure;

FIG. 8 is a fragmentary partly exploded cross-sectional view of a fifth embodiment of the rimless eyeglasses of the present disclosure;

FIG. 9 illustrates a lens having inner and outer through holes, each of which is in the shape of an ellipse;

FIG. 10 illustrates a lens having inner and outer through hole units, each of which is in the shape of a rectangle; and

FIG. 11 illustrates a lens having inner and outer through hole units, each of which is in the shape of a polygon.

### DETAILED DESCRIPTION

Before the disclosure is described in greater detail with reference to the accompanying embodiments, it should be noted herein that like elements are denoted by the same reference numerals throughout the disclosure.

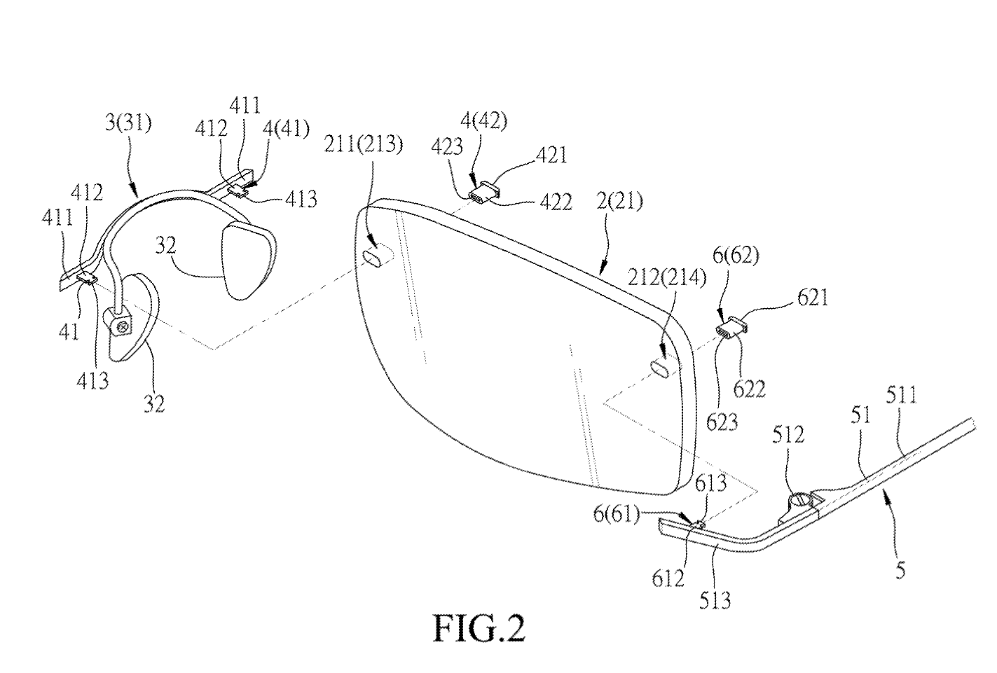

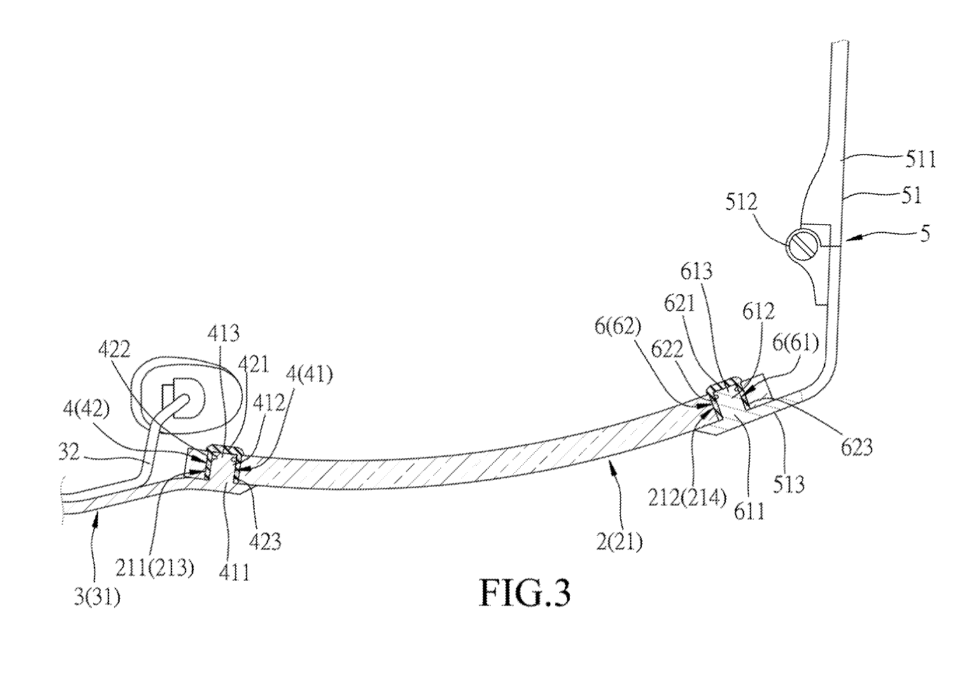

Referring to FIGS. 2 and 3, a first embodiment of a pair of rimless eyeglasses according to the present disclosure includes a lens unit 2, a bridge unit 3, a bridge fixing unit 4, a temple unit 5 and a temple fixing unit 6. Since the rimless eyeglasses have symmetrical left and right parts, only the left part of the rimless eyeglasses is illustrated in FIGS. 2 and 3 for the sake of brevity.

The lens unit 2 includes two spaced-apart lenses 21, each of which is formed with an inner through hole unit 211 and an outer through hole unit 212. In this embodiment, the inner through hole unit 211 has a noncircular inner through hole 213 proximate to the other one of the lenses 21. The inner through hole 213 has a pair of orthogonal major and minor axes. The major axis is substantially parallel to an axis that passes through the inner through hole units 211 of the lenses 21, and has a length larger than that of the minor axis. The outer through hole unit 212 has a noncircular outer through hole 214 distal from the other one of the lenses 21. The outer through hole 214 has a pair of orthogonal major and minor axes. The major axis is substantially parallel to an axis that passes through the outer through hole units 212 of the lenses 21, and has a length larger than that of the minor axis.

The bridge unit 3 includes a bridge 31 to which the lenses 21 are connected, and two nose pads 32 which extends from the bridge 31 for abutting against a user's nasal bridge and supporting the bridge 31.

The bridge fixing unit 4 includes two bridge engaging members 41 that are disposed on opposite ends of the bridge 31, and two bridge fixing members 42. Each of the bridge engaging members 41 has a bridge engaging base 411, a bridge engaging arm 412 that extends from the bridge engaging base 411, and a bridge engaging head 423 that projects from a distal end of the bridge engaging arm 412. The bridge engaging head 413 of each of the bridge engaging members 41 has a cross-section having the shape of a double-bitted axe blade. Each of the bridge fixing members 42 has a bridge fixing base 421 and a bridge fixing wall 422 that projects from the bridge fixing base 421 and that defines a receiving space 423.

It should be noted that, in the first embodiment of the present disclosure, the bridge engaging heads 413 of the bridge engaging members 41 are resiliently deformable. However, the bridge fixing walls 422 of the bridge fixing members 42 may also be configured to be resiliently deferrable. In an alternative embodiment, only the bridge fixing walls 422 of the bridge fixing members 42 are resiliently deformable.

The bridge engaging arm 412 and the bridge engaging head 413 of each of the bridge engaging members 41 are inserted into the inner through hole 213 of a respective one of the inner through hole units 211 of the lenses 21 from one side of the lenses 21. The bridge fixing wall 422 of each of the bridge fixing members 42 is inserted info the inner through hole 213 of a respective one of the inner through hole units 211 of the lenses 21 from an opposite side of the lenses 21 such that the bridge engaging arm 412 of each of the bridge engaging members 41 is received in the receiving space 423 of the bridge fixing wall 422 of a respective one of the bridge fixing members 42 and that the bridge engaging head 413 of each of the bridge engaging members 41 is fittingly but detachably engaged in the receiving space 423 of the bridge fixing wall 422 of the respective one of the bridge fixing members 42 so as to fix the lenses 21 to the bridge 31. The bridge engaging base 411 of each of the bridge engaging members 41 abuts against the one side of a respective one of the lenses 21. The bridge fixing base 421 of each of the bridge fixing members 42 abuts against the opposite side of a respective one of the lenses 21.

The temple unit 5 includes two temples 51, each of which includes a connecting body 513, a hinge 512 that is disposed on an end of the connecting body 513, and a temple body 511 that is connected pivotally to the hinge 512.

The temple fixing unit 6 includes two temple engaging members 61 and two temple fixing members 62. Each of the temple engaging members 61 is disposed on the connecting body 513 of a respective one of the temples 51 at a position opposite to the hinge 512 of the respective one of the temples 51. Each of the temple fixing members 62 has a temple fixing base 621 and a temple fixing wall 622 that projects from the temple fixing base 621 and that defines a receiving space 623. Each of the temple engaging members 61 has a temple engaging base 611, a temple engaging arm 612 that extends from the temple engaging base 611, and a temple engaging head 613 that projects from the temple engaging arm 612. The temple engaging head 613 of each of the temple engaging members 61 has a cross-section having the shape of a double-bitted axe blade.

It should be noted that, in the first embodiment of the present disclosure, the temple engaging heads 615 of the temple engaging members 61 are resiliently deferrable. However, the temple fixing walls 622 of the temple fixing members 62 may also be configured to be resiliently deformable. In another alternative embodiment, only the temple fixing walls 622 of the temple fixing members 62 are resiliently deformable.

The temple engaging arm 612 and the temple engaging head 613 of each of the temple engaging members 61 are inserted into the outer through hole 214 of a respective one of the outer through hole units 212 of the lenses 21 from the one side of the lenses 21. The temple fixing wall 622 of each of the temple fixing members 62 is inserted into the outer through hole 214 of a respective one of the outer through hole units 212 of the lenses 21 from the opposite side of the lenses 21 such that the temple engaging arm 612 is received in the receiving space 623 and the temple engaging head 613 of each of the temple engaging members 61 detachably and fittingly engages in the receiving space 623 of the temple fixing wall 622 of a respective one of the temple fixing members 62 so as to respectively fix the temples 51 to the lenses 21. The temple engaging base 611 of each of the temple engaging members 61 abuts against the one side of a respective one of the lenses 21. The temple fixing base 621 of each of the temple fixing members 62 abuts against the opposite side of a respective one of the lenses 21.

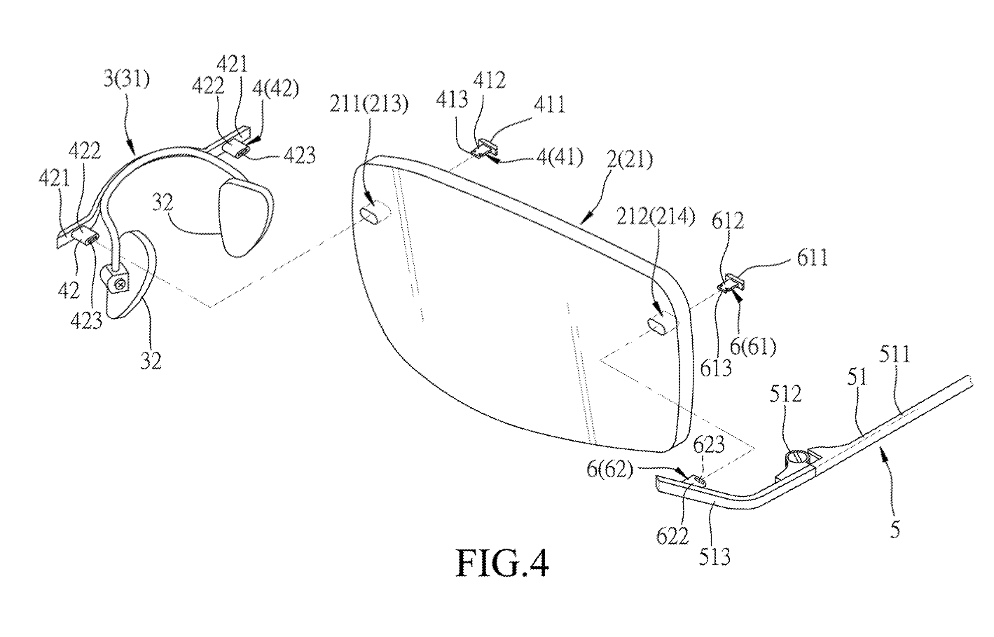

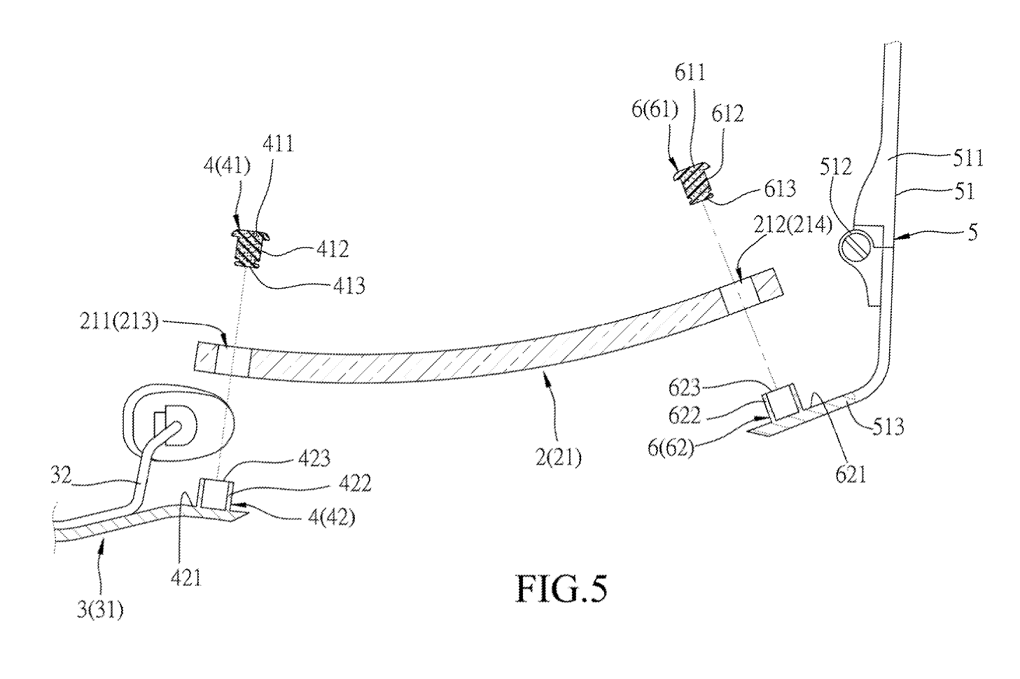

Referring to FIGS. 4 and 5, a second embodiment of the rimless eyeglasses according to the present disclosure has a structure similar to that of the first embodiment. The differences reside in that the locations of the bridge fixing members 42 and the bridge engaging members 41 are interchanged, and that the locations of the temple fixing members 62 and the temple engaging members 61 are interchanged.

Te be more specific, the bridge fixing wall 423 of each of the bridge fixing members 42 is inserted into the inner through hole 213 of a respective one of the inner through hole units 211 of the lenses 21 from the one side of the lenses 21. The bridge engaging arm 412 and the bridge engaging head 413 of each of the bridge engaging members 41 are inserted into the inner through hole 213 of a respective one of the inner through hole units 211 of the lenses 21 from the opposite side of the lenses 21. The temple fixing wall 622 of each of the temple fixing members 62 is inserted into the outer through hole 214 of a respective one of the outer through hole units 212 of the lenses 21 from the one side of the lenses 21. The temple engaging arm 612 and the temple engaging head 613 of each of the temple engaging members 61 are inserted into the outer through hole 214 of a respective one of the outer through hole units 212 of the lenses 21 from the opposite side of the lenses 21.

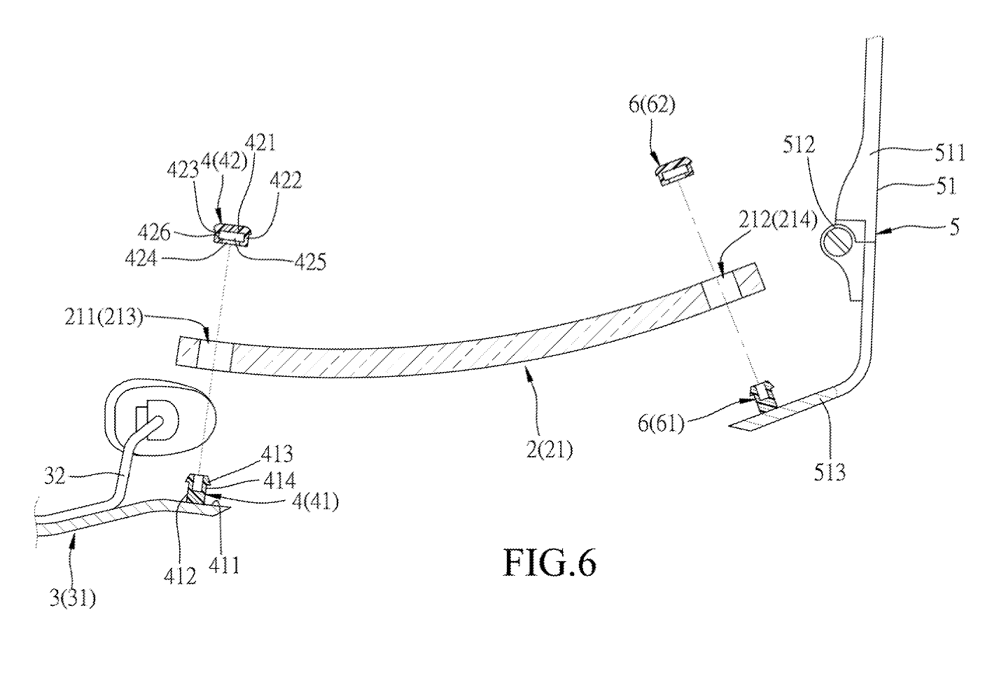

Referring to FIG. 6, a third embodiment of the rimless eyeglasses according to the present disclosure has a structure similar to that of the first embodiment. The differences reside in the structures of the bridge fixing unit 4 and the temple fixing unit 6.

The bridge fixing unit 4 includes two bridge engaging members 41 that are disposed on opposite ends of the bridge 31, and two bridge fixing members 42. Each of the bridge engaging members 41 has a bridge engaging base 411, a bridge engaging arm 412 that has a plurality of bridge engaging arm portions 414 extending from the bridge engaging base 411, and a plurality of bridge engaging heads 413 projecting respectively from the bridge engaging arm portions 414. Each of the bridge fixing members 42 has a bridge fixing base 421 and a bridge fixing wall 422 that projects from the bridge fixing base 421 and that defines a receiving space 423, which has a small hole part 424 and a large hole part 425 that cooperatively define an abutting portion 426.

It should be noted that, in the third embodiment of the present disclosure, the bridge engaging heads 413 of the bridge engaging members 41 are resiliently deformable. However, the bridge fixing walls 422 of the bridge fixing members 42 may also be configured to be resiliently deformable. In another alternative embodiment, only the bridge fixing walls 422 of the bridge fixing members 42 are resiliently deformable.

The bridge engaging arm 412 and the bridge engaging heads 42.3 of each of the bridge engaging members 41 are inserted into the inner through hole 213 of a respective one of the inner through hole units 211 of the lenses 21 from the one side of the lenses 21. The bridge fixing wall 422 of each of the bridge fixing members 42 is inserted into the inner through hole 213 of a respective one of the inner through hole units 211 of the lenses 21 from the opposite side of the lenses 21 such that the bridge engaging arm 412 of each of the bridge engaging members 41 is received in the receiving space 423 of a respective one of the bridge fixing members 42 and that the bridge engaging head 413 of each of the bridge engaging members 41 is received in the large hole part 425 of the receiving space 423 of the respective one of the bridge fixing members 42, abuts against the abutting portion 42 of the respective one of the bridge fixing members 42, and detachably and fittingly engages in the receiving space 423 of the respective one of the bridge fixing members 42 so as to fix the lenses 21 to the bridge 31. The bridge engaging base 411 of each of the bridge engaging members 41 abuts against the one side of a respective one of the lenses 21. The bridge fixing base 421 of each of the bridge fixing members 42 abuts against the opposite side of a respective one of the lenses 21.

The temple fixing unit 6 includes two temple engaging members 61 and two temple fixing members 62. Each of the temple engaging members 61 has a structure the same as that of a respective one of the bridge engaging members 41 and each of the temple fixing members 62 has a structure the same as that of a respective one of the bridge fixing members 42, further elaboration regarding the structures of the temple engaging members 61 and the temple fixing members 62 will not be presented here for the sake of brevity.

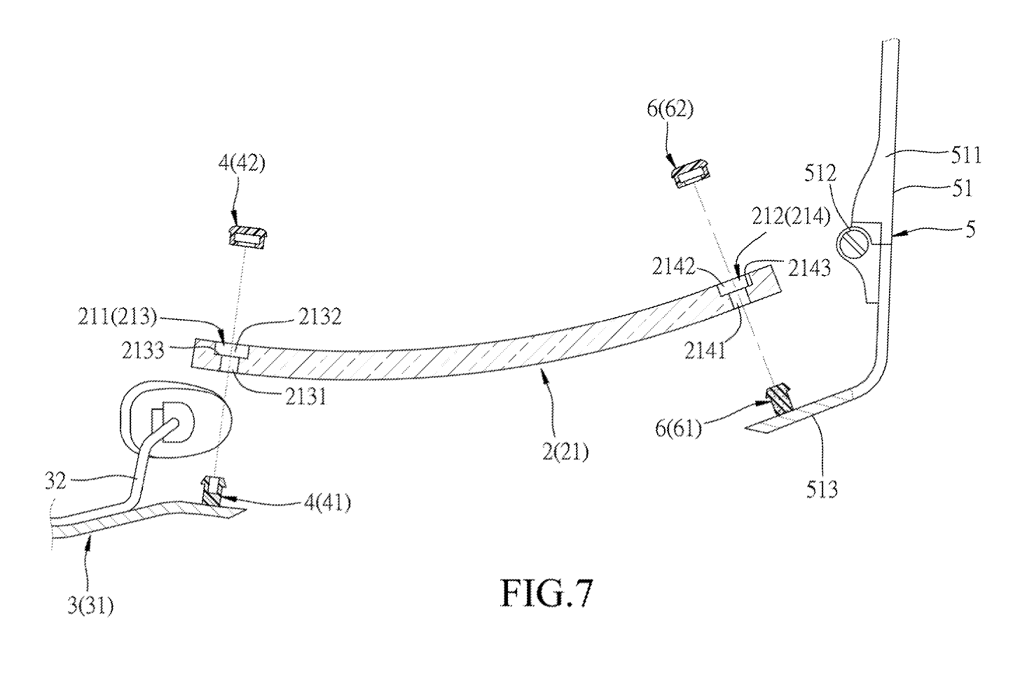

Referring to FIG. 7, a fourth embodiment of the rimless eyeglasses according to the present disclosure has a structure similar to that of the third embodiment. The differences reside in the structures of the inner through hole 213 of the inner through hole unit 211 and the outer through hole 214 of the outer through hole unit

212 of each of the lenses 21.

The inner through hole 213 of the inner through hole unit 211 of each of the lenses 21 has small and large hole parts 2131, 2132 that are in spatial communication with each other and that cooperatively define an inner abutting portion 2133 therebetween. Each of the bridge engaging members 41 of the bridge fixing unit 4 extends through the small hole part 2131 of the inner through hole 213 of the inner through hole unit 211 of a respective one of the lenses 21. Each of the bridge fixing members 42 of the bridge fixing unit 4 is completely received in the large hole part 2132 of the inner through hole 213 of the inner through hole unit 211 of a respective one of the lenses 21, abuts against the inner abutting portion 2133, and engages detachably a respective one of the bridge engaging members 41 of the bridge fixing unit 4.

It should be noted that, with the bridge fixing members 42 of the bridge fixing unit 4 being respectively received in the large hole parts 2132 of the inner through holes 213, the rimless eyeglasses may have a sleek look and improved aesthetic appearance.

The outer through hole 214 of the outer through hole unit 212 of each of the lenses 21 has small and large hole parts 2141, 2142 that are in spatial communication with each other and that cooperatively define an outer abutting portion 2143 therebetween. Each of the temple engaging members 61 of the temple fixing unit 6 extends through the small hole part 2141 of the outer through hole 214 of the outer through hole unit 212 of a respective one of the lenses 21. Each of the temple fixing members 62 of the temple fixing unit 6 is completely received in the large hole part 2142 of the outer through hole 214 of the outer through hole unit 212 of a respective one of the lenses 21, abuts against the outer abutting portion 2143, and engages detachably a respective one of the temple engaging members 61 of the temple fixing unit 6.

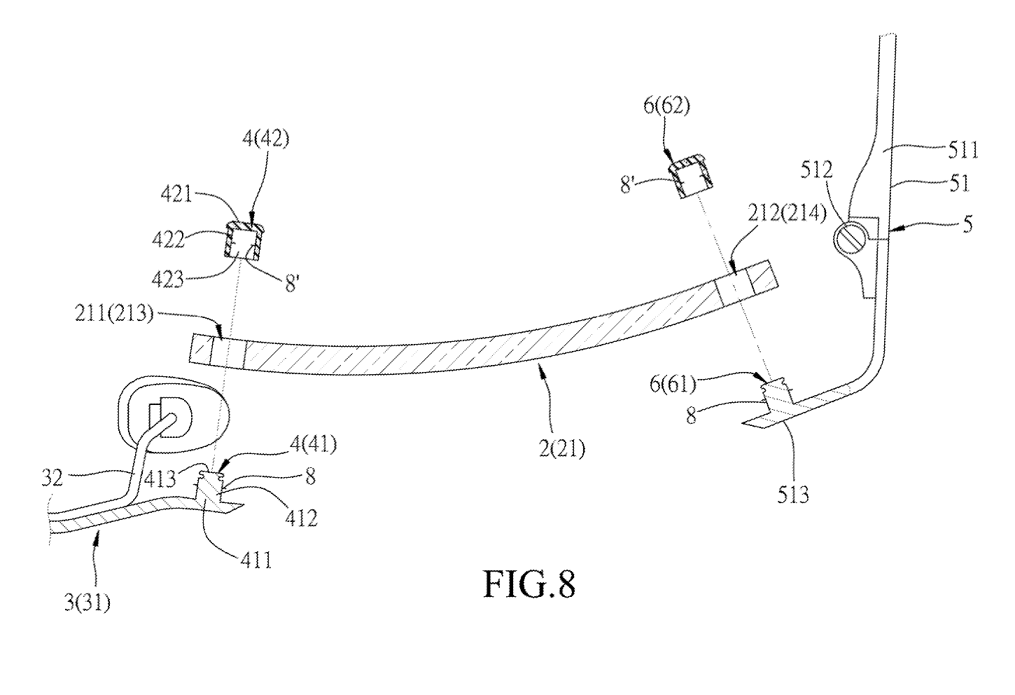

Referring to FIG. 8, a fifth embodiment of the rimless eyeglasses according to the present disclosure has a structure similar to that of the first embodiment. The differences reside in that the bridge engaging arm 412 of each of the bridge engaging members 41 is formed with a plastic welding wire 8, and the bridge fixing wall 422 of each of the bridge fixing members 42 is formed with a plastic welding wire 8′ that is in the receiving space 423 and that is coupled to the welding wire 8 on a respective one of the bridge engaging members 41 by ultrasonic welding technique. The receiving spaces 423 of each of the fixing members 42 are configured to conceal a melted portion of the welding wires 8, 8′ during the ultrasonic welding process of the welding wires 8, 8′.

Each of the temple engaging members 61 has a structure the same as that of a respective one of the bridge engaging members 41 and each of the temple fixing members 62 has a structure the same as that of a respective one of the bridge fixing members 42, further elaboration regarding the structures of the temple engaging members 61 and the temple fixing members 62 will not be presented here for the sake of brevity.

It should be noted that each of the inner through hole units 211 may have a plurality of the inner through holes 213 that are aligned along an axis passing through the inner through hole units 211, and each of the outer through hole units 212 may have a plurality of the outer through holes 214 that are aligned along an axis passing through the outer through hole units 212. The bridge fixing unit 4 may have a plurality of the bridge engaging members 41 and a plurality of the bridge fixing members 42, which correspond in number to that of the inner through holes 213. The temple fixing unit 6 may have a plurality of the temple engaging members 61 and a plurality of the temple fixing members 62, which correspond, in number to that of the outer through holes 214. Therefore, the lenses 21 of the lens unit 2 may be firmly fixed to the bridge 31 of the bridge unit 3, and the temples 51 of the temple unit 5 maybe respectively and firmly fixed to the lenses 21.

It should be added that the number of the temples 51 of the temple unit 5 is not limited to two, and may be altered or even omitted, as long as the lenses 21 of the lens unit 2 is able to be respectively positioned in front of the user's eyes for viewing.

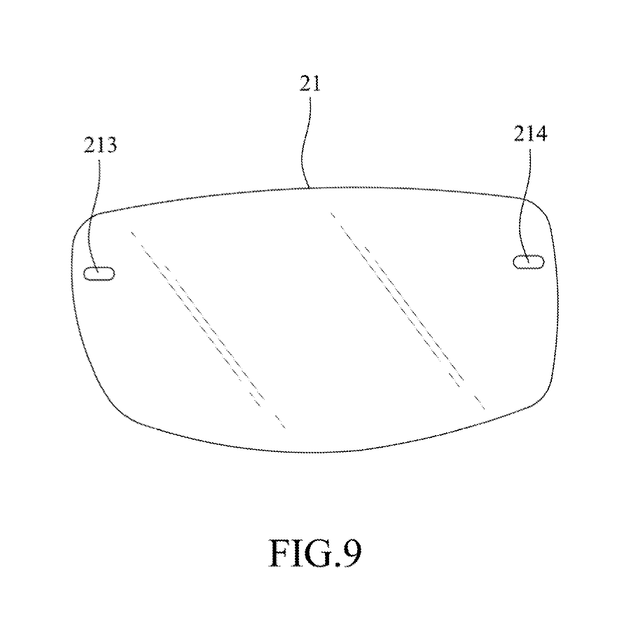

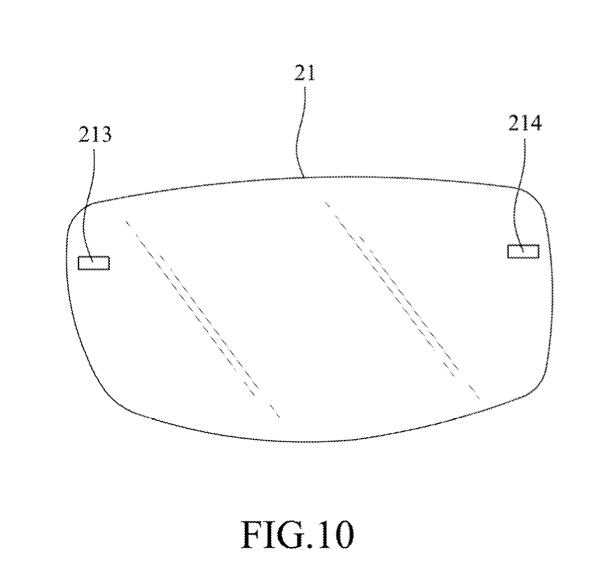

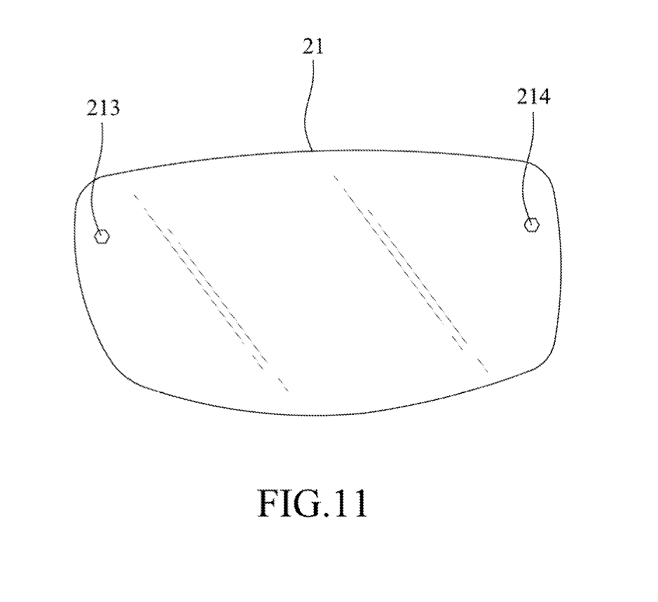

Referring to FIGS. 9 to 11, the inner through hole 213 and the outer through hole 214 may each have the shape of a racetrack (see FIG. 9), an ellipse, a flower, a rectangle (see FIG. 10) or a polygon (see FIG. 11) for an improved aesthetic appearance. Alternatively, each of the inner through hole 213 and the outer through hole 214 may be configured to be non-symmetrical in shape, misconnections between the bridge unit 3 and the lens unit 2 or between the temple unit 5 and the lens unit 2 can be prevented.

To sum up, the present disclosure facilitates assembly and maintenance of the rimless eyeglasses by virtue of the configuration of the bridge fixing unit 4 and the temple fixing unit 6. Each of the bridge engaging members 41 of the bridge engaging unit 4 is capable of easily and fittingly engaging a respective one of the bridge fixing members 42. Likewise, each of the temple engaging members 61 of the temple fixing unit 6 is capable of easily and fittingly engaging a respective one of the temple fixing members 62. The integrity of the rimless eyeglasses may thereby be unaffected even after long-term use.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A pair of rimless eyeglasses comprising:
a lens unit including a pair of spaced-apart lenses, each of which is formed with an inner through hole unit that has at least one noncircular inner through hole proximate to the other one or said lenses;
a bridge unit including a bridge; and
a bridge fixing unit including
a pair of bridge engaging members that are disposed on opposite ends of said bridge, each of said bridge engaging members having a bridge engaging base and a bridge engaging head that projects from said bridge engaging base, and
a pair of bridge fixing members, each of said bridge fixing members having a bridge fixing base and a bridge fixing wall that projects from said bridge fixing base and that defines a receiving space, said bridge engaging heads of said bridge engaging members and/or said bridge fixing walls of said bridge fixing members being resiliently deformable, said bridge engaging head of each of said bridge engaging members being inserted into said inner through hole of a respective one of said inner through hole units of said lenses from one side of said lenses, said bridge fixing wall of each of said bridge fixing members being inserted into said inner through hole of a respective one of said inner through hole units of said lenses from an opposite side of said lenses such that said bridge engaging head of each of said bridge engaging members detachably and fittingly engages in said receiving space of said bridge fixing wall of a respective one of said bridge fixing members so as to fix said lenses to said bridge.

2. The pair of rimless eyeglasses as claimed in claim 1, wherein said at least one inner through hole of each of said inner through hole units has a pair of orthogonal major and minor axes, the major axis being substantially parallel to an axis that passes through said inner through hole units and having a length larger than that of the minor axis.

3. The pair of rimless eyeglasses as claimed in claim 1, wherein said at least one inner through hole of each of said inner through hole units has the shape of a racetrack, an ellipse, a flower or a polygon.

4. The pair of rimless eyeglasses as claimed in claim 1, wherein:
said at least one inner through hole of each of said inner through hole units has small and large hole parts that are in spatial communication with each other and that cooperatively define an inner abutting portion therebetween;
each of said bridge engaging members of said bridge fixing unit extends through said small hole part of said inner through hole of said inner through hole unit of a respective one of said lenses; and
each of said bridge fixing members of said bridge fixing unit is received in said large hole pars of said inner through hole of said inner through hole unit of a respective one of said lenses, abuts against said inner abutting port ion, and engages detachably a respective one of said bridge engaging members of said bridge fixing unit.

5. The pair of rimless eyeglasses as claimed in claim 1, wherein each of said inner through hole units has a plurality of said inner through holes that are aligned along an axis passing through said inner through hole units.

6. The pair of rimless eyeglasses as claimed in claim 5, wherein each of said inner through holes has the shape of a racetrack, an ellipse, a flower or a polygon.

7. The pair of rimless eyeglasses as claimed in claim 1, wherein said bridge unit further includes a pair of nose pads extending from said bridge.

8. The pair of rimless eyeglasses as claimed in claim 1, wherein each of said lenses is further formed with an outer through hole unit that has at least one noncircular outer through hole distal from the other one of said lenses, said pair of rimless eyeglasses further comprising a temple unit that includes a pair of temples, and a temple fixing unit that includes a pair of temple engaging members respectively disposed on said temples, and a pair of temple fixing members, said temple engaging members being respectively inserted into said cuter through hole units from said one side of said lenses, said temple fixing members being respectively inserted into said outer through hole units from said opposite side of said lenses to engage detachably with said temple engaging members so as to respectively fix said temples to said lenses.

9. The pair of rimless eyeglasses as claimed in claim 8, wherein each of said temple fixing members has a temple fixing base and a temple fixing wall that projects from said temple fixing base and that defines a receiving space, each of said temple engaging members having a temple engaging base and a temple engaging head that projects from said temple engaging base, said temple engaging heads of said temple engaging members and/or said temple fixing walls of said temple fixing members being resiliently deformable, said temple engaging head of each of said temple engaging members detachably and fittingly engaging in said receiving space of said temple fixing wall of a respective one of said temple fixing members.

10. The pair of rimless eyeglasses as claimed in claim 8, wherein each of said temples includes a connecting body on which a respective one of said temple engaging members is disposed, a hinge disposed on said connecting body opposite to said respective one of said temple engaging members, and a temple body connected pivotally to said hinge.

11. The pair of rimless eyeglasses as claimed in claim 8, wherein said at least one outer through hole of each of said outer through hole units has the shape of a racetrack, an ellipse, a flower or a polygon.

12. The pair of rimless eyeglasses as claimed in claim 8, wherein said at least one outer through hole of each of said outer through hole units has a pair of orthogonal major and minor axes, the major axis being substantially parallel to an axis that passes through said outer through hole units and having a length larger than that of the minor axis.

13. The pair of rimless eyeglasses as claimed in claim 8, wherein:
said at least one outer through hole of each of said outer through hole units has small and large hole parts that are in spatial communication with each other and that cooperatively define an outer abutting portion therebetween;
each of said temple engaging members of said temple fixing unit extends through said small hole part of said outer through hole of said outer through hole unit of a respective one of said lenses; and
each of said temple fixing member of said temple fixing unit is received in said large hole part of said outer through hole of said outer through hole unit of a respective one of said lenses, abuts against said outer abutting portion, and engages detachably a respective one of said temple engaging members of said temple fixing unit.

14. The pair of rimless eyeglasses as claimed in claim 8, wherein each of said outer through hole units has a plurality of outer through holes that are aligned along an axis passing through said outer through hole units.

15. The pair of rimless eyeglasses as claimed in claim 14, wherein each of said outer through holes has the shape of a racetrack, an ellipse, a flower or a polygon.
